(19) United States
(12) Patent Application Publication
(10) Pub. No.: US 2009/0122987 A1
(43) Pub. Date: May 14, 2009

(54) Enhanced transmission systems for use in wireless personal area networks

(76) Inventors: Shaomin Samuel Mo, Monmouth Junction, NJ (US); Alexander D. Gelman, Smallwood, NY (US)

Correspondence Address: RATNERPRESTIA, P.O. BOX 980, VALLEY FORGE, PA, 19482, US

(21) Appl. No.: 11/665,624

(22) PCT Filed: Oct. 18, 2005
(86) PCT No.: PCT/US05/37629

§ 371 Date: Apr. 17, 2007

Related U.S. Application Data
(60) Provisional application No. 60/620,069, filed on Oct. 19, 2004.

(51) Int. Cl. H04L 9/00

(52) U.S. Cl. 380/277

(57) ABSTRACT

Method and computer program products for enhancing wireless communication in a wireless network are disclosed. In the wireless network, frames of data are transmitted in bursts. Wireless communication is enhanced by transmitting a first frame of source data that is scrambled using a scrambling sequence in a first burst, storing an indicator corresponding to the scrambling sequence for the first frame, identifying the scrambling sequence of the first frame for retransmission of the first frame, retransmitting the first frame (which is scrambled using the identified scrambling sequence) in a subsequent burst, receiving the transmitted and retransmitted first frames, and processing the received transmitted and retransmitted first frames to recover the source data.

### FIELD OF THE INVENTION

The present invention relates to the field of wireless networking and, more particularly, to enhanced transmission systems for use in wireless personal area networks.

### BACKGROUND OF THE INVENTION

Wireless personal area networks (WPANs) provide wireless short-range connectivity for electronic devices such as audio/video devices within a home. Current standards proposed by the Institute of Electrical and Electronics Engineers (IEEE) task group for development of WPANs call for the simultaneous operation of several WPAN compatible electronic devices, which can lead to unreliable channel conditions due to interference. In addition, unreliable channel conditions may result from interference due to other electrical/electronic devices within the operating environment of the WPAN compatible electronic devices.

There is an ever present desire to improve communication among wireless network devices such as WPAN compatible electronic devices. Undesirable channel conditions adversely affect communication between such devices. Accordingly, methods and computer program products are needed to address the effect of undesirable channel conditions. The present invention addresses this need among others.

### SUMMARY OF THE INVENTION

The present invention is embodied in methods and computer program products for enhancing wireless communication in a wireless network. In the wireless network, frames of data are transmitted in bursts. Wireless communication is enhanced by transmitting a first frame of source data that is scrambled using a scrambling sequence in a first burst, storing an indicator corresponding to the scrambling sequence for the first frame, identifying the scrambling sequence of the first frame for retransmission of the first frame, retransmitting the first frame (which is scrambled using the identified scrambling sequence) in a subsequent burst, receiving the transmitted and retransmitted first frames, and processing the received transmitted and retransmitted first frames to recover the source data.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Included in the drawings are the following figures:

FIG. 1 is a block diagram of an exemplary transmitter in accordance with an aspect of the present invention;

FIG. 2 is a block diagram of an exemplary receiver in accordance with an aspect of the present invention;

FIG. 3 is a table depicting a prior art physical layer frame format;

FIG. 4 is a table depicting a prior art physical layer header format;

FIG. 5 is a table depicting a prior art MAC layer header format;

FIG. 6 is a table depicting a prior art fragmentation control field format;

FIG. 7 is a timing diagram depicting an acknowledgment and retransmission example for use in describing an aspect of the present invention;

FIG. 8 is a timing diagram depicting an acknowledgement and retransmission example for use in describing extraction of a frame number in accordance with an aspect of the present invention;

FIG. 9 is a table depicting header check-sum checking results for a frame and a retransmission of the frame in accordance with an aspect of the present invention;

FIG. 10 is a timing diagram depicting an acknowledgement and retransmission example for use in describing the indication of the start of a burst of frames in accordance with an aspect of the present invention;

FIG. 11 is a flowchart depicting exemplary transmitting steps in accordance with an aspect of the present invention; and

FIG. 12 is a flowchart depicting exemplary receiving steps in accordance with an aspect of the present invention.

### DETAILED DESCRIPTION OF THE INVENTION

The present invention is described with reference to the Open Systems Interconnection (OSI) reference model to facilitate description. The OSI reference model sets forth layers present in electronic devices, such as a WPAN compatible electronic devices, to process messages communicated over the network. The OSI reference model includes a physical layer, a data-link layer, a network layer, a transport layer, a session layer, a presentation layer, and an application layer. A message originating at a first electronic device for delivery to a second electronic device passes from the application layer of the first electronic device through each layer to the physical layer, which communicates the message over the network, i.e., a wireless network in a WPAN system. The second electronic device receives the message through its physical layer and the message is processed through each layer of the second electronic device to retrieve the message from the first electronic device. The data-link layer includes a media access control (MAC) layer and a logical link control layer.

In an exemplary embodiment, the present invention may be implemented in the MAC layer and the physical layer as an enhancement to communication systems in accordance with proposed IEEE standard P802.15.3 ™ Draft Standard for Telecommunications and Information Exchange Between Systems (referred to herein as the proposed IEEE standard). The proposed IEEE standard uses a hybrid automatic repeat request (HARQ) scheme to deal with unreliable channel conditions. The HARQ scheme employs a conventional automatic repeat request (ARQ) scheme together with a forward error correction (FEC) technique. If an error is detected, e.g., through a cyclic redundancy check (CRC), the receiving electronic device requests that the transmitting electronic device resend the erroneously received data packets.

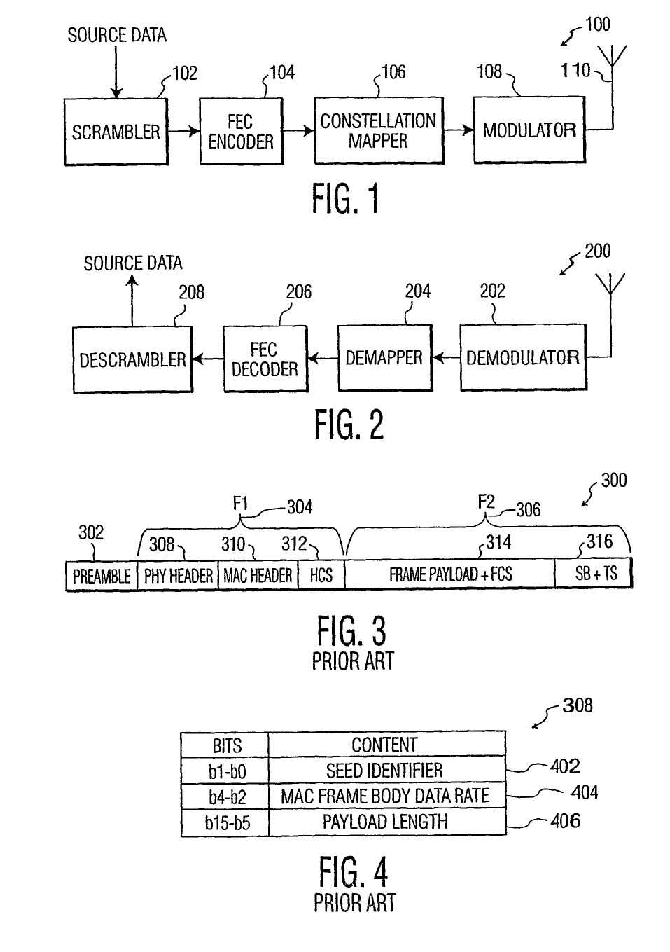

FIG. 1 depicts a transmitter 100 of a wireless electronic device (herein wireless device), which forms part of a physical layer for the wireless device. The illustrated transmitter 100 includes a scrambler 102, an FEC encoder 104, a constellation mapper 106, and a modulator 108. The scrambler 102 scrambles source data, the FEC encoder 104 introduces error correction to the source data, the constellation mapper 106 maps the scrambled and FEC encoded source data in accordance with a constellation mapping scheme, and the modulator 108 modulates the resultant source data onto a carrier for transmission in frames via an antenna 110.

In an exemplary embodiment, the scrambler 102 uses a 15-bit Linear Feedback Shift Register (LFSR) to generate a pseudo random binary sequence (PRBS). The scrambler may be initialized with one of Four seeds per frame. The seed identifier may be contained in a physical layer header (PHY header) attached to messages for transmission over the network, which is described in further detail below. The 15-bit seed value chosen corresponds to the seed identifier value, which may be set to 00 when the PHY layer is initialized and incremented using a 2-bit rollover counter for each frame that is sent by the PHY layer, i.e., the seeds may be chosen incrementally and circularly.

FIG. 2 depicts a receiver 200 of another wireless device, which forms part of a physical layer of the other wireless device. The illustrated receiver 200 includes a demodulator 202, demapper 204, decoder 206, and descrambler 208. The modulated carrier transmitted by the transmitter 100 of a first wireless device is received at the receiver 200 of another wireless device via another antenna 210. The demodulator 202 reverses the modulation introduced by the modulator 108 (FIG. 1), the demapper 204 reverses the mapping introduced by the constellation mapper 106 (FIG. 1), the FEC decoder 206 decodes the encoding introduced by the FEC encoder 104 (FIG. 1), and the descrambler 208 reverses the scrambling introduced by the scrambler 102 (FIG. 1) to recover the source data. In an exemplary embodiment, the receiver 200 includes a storage device (not shown).

In an exemplary embodiment, the source data is communicated in frames. FIG. 3 depicts an exemplary format for a physical layer frame 300 communicated between a physical layer transmitter 100 (FIG. 1) and receiver 200 (FIG. 2), referred to herein as the PHY frame 200. The illustrated PHY frame 200 includes a preamble field 302, a frame header portion 304, and a frame payload portion 306. The frame header portion 304 includes a physical layer header (PHY header) field 308, a MAC layer header (MAC header) field 310, and a header checksum (HCS) field 312. The frame payload portion 306 includes a frame body 314 (including a frame payload and frame checksum “FCS”) 314 and a stuff bit (SB) and tail symbol (TS) section 316.

FIG. 4 depicts an exemplary PHY header 308. The illustrated PHY header 308 includes a seed identifier field 402 for the scrambler/descrambler, a MAC frame body data rate field 404, and a frame payload length field 406 (which generally does not include the FCS).

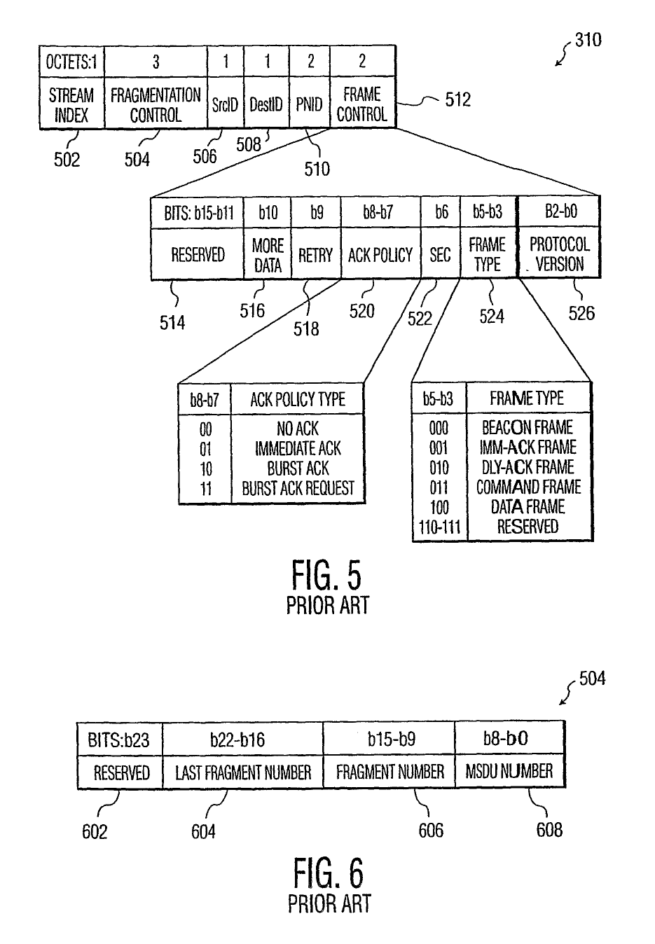

FIG. 5 depicts an exemplary MAC header 310. The MAC header 310 includes a stream index field 502, a fragmentation control field 504, a source identifier (SrcID) field 506, a destination identifier (DestID) field 508, a piconet identifier (PNID) field 510, and a frame control field 512, which includes a reserved bits field 514, a more data bit field 516, a retry bit field 518, an acknowledgement (ACK) policy field 520, a security (SEC) field 522, a frame type field 524, and a protocol version field 526. The MAC layer in a transmitter 100 may fragment frames exceeding a predefined size into smaller frames for transmission (referred to herein a MAC service data units or MSDUs). The MAC layer in a receiver 200 then assembles the fragmented frames before passing them to an upper layer, e.g., the network layer. The fragmentation control field 504 in the MAC header 310 includes fragmentation control bytes, e.g., 3 bytes (“octets”), that may be used for assembling the fragmented frames.

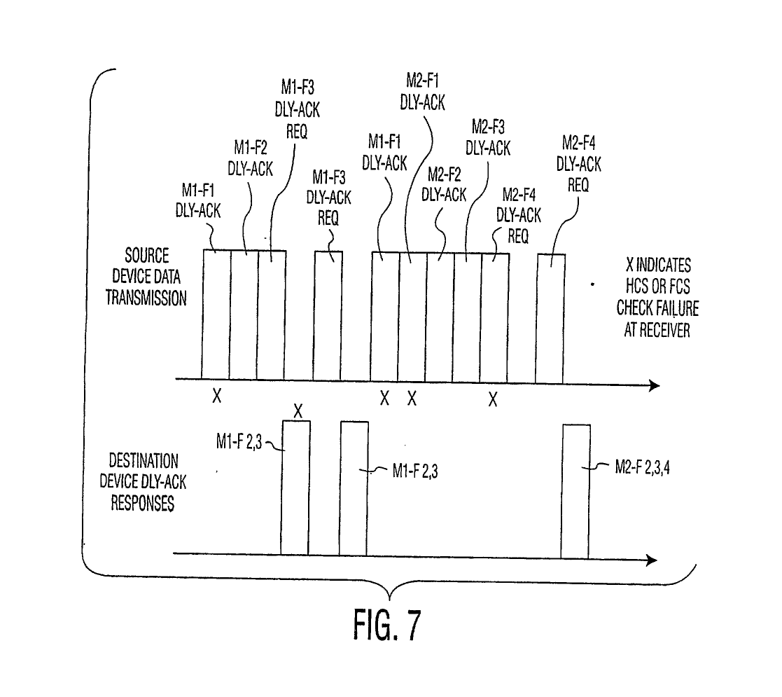

FIG. 6 depicts an exemplary fragmentation control field 504. The illustrated fragmentation control field 504 includes a reserved bit field 602, a last fragment number field 604, a fragment number field 606, and a MAC service data unit (MSDU) field 608 indicating the sequence number of the current MSDU. The fragment number field 606 indicates the order of the current fragment within the current MSDU. The last fragment number field 604 indicates the total number of fragments within the current MSDU.

In an exemplary use, to transmit a frame, payload data is passed from an upper layer (e.g., the network layer) of a transmitting wireless device to the MAC layer in the data-link layer. The MAC layer fragments the source data into MSDUs, adds an appropriate MAC header to each MSDU, and passes the resultant data stream (“source data”) to the PHY layer. The PHY layer adds the PHY header 308 to the MAC header 310, calculates the HCS 312 for the combined PHY header 308 and MAC header 310, and appends the HCS 312 to the end of the MAC header 310. If the size of the MAC frame body 314 (i.e., the frame payload plus FCS) in bits is not an integer multiple of the bits/symbols, then stuff bits (SB) and tail symbols (TS) are added following the MAC frame body 314. During transmission of the frame, the PHY preamble 302 is sent first; followed by the PHY header 308, MAC header 310, and HCS 312; followed by the MAC frame body 314; and followed by stuff bits and tail symbols, if necessary.

Upon receiving a frame, a receiver 200 in a receiving wireless device processes the preamble 302 to synchronize the data received from the transmitter 100 of the transmitting wireless device. The receiver 200 then calculates an HCS from the PHY header and MAC header and compares it to the HCS 312 in the PHY frame 300. If the HCS in the PHY frame is the same as the calculated HCS, the receiver 200 decodes the frame payload portion 306 based on the PHY header 308 information (i.e., seed identifier 602, MAC frame body data rate 604, and payload length 606). The receiver 200 then calculates the FCS based on the frame payload in the frame body, if the calculated FCS is the same as the FCS in the frame, the frame is considered correctly received. If either the HCS or the FCS fails, the frame is treated as a failed transmission and is saved for additional processing as described in further detail below.

In an exemplary embodiment, receivers 200 send an acknowledgement message to transmitters 100 to indicate whether a received frame is correctly demodulated. The proposed IEEE standard supports two acknowledgement types for use with the present invention. The acknowledgment types include immediate acknowledgement (Imm-ACK) and delayed acknowledgement (Dly-ACK), which are described in further detail below. In an alternative exemplary embodiment, receivers 200 do not send acknowledgement messages, which is in accordance with the proposed IEEE standard for a non-acknowledgement (No-ACK) type.

A transmitting wireless device that transmits a frame with an ACK Policy set to 1 mm-ACK expects an immediate acknowledgement from the intended receiving wireless device. If the intended receiving wireless device correctly receives the frame, it immediately sends an acknowledge frame back to the transmitting wireless device.

A transmitting wireless device that transmits a frame with an ACK Policy set to Dly-ACK expects an acknowledgement from the intended receiving wireless device when a Dly-ACK request (Req) is sent. When responding to a Dly-ACK request, the receiving device acknowledges receipt of all frames received since the last Dly-ACK request. If a response to the Dly-ACK request is not received at the transmitting device, the last data frame of the burst is repeated until an acknowledgement is received. Dly-ACK is designed to reduce acknowledgement times for burst transmission.

FIG. 7 depicts acknowledgement and retransmission of fragmented MSDUs with a Del-ACK policy setting. M stands for MSDU and F stands for Fragment. Mm-Ff represents Fragment f of MSDU m. The top row represents frames sent from the transmitting device to the receiving device and the bottom row represents acknowledgments sent from the receiving device to the transmitting device. An “X” in the top row represents frames that did not pass a HCS or FCS check (i.e., included errors) and an “X” in the bottom row represents acknowledgments sent by the receiving device that were not properly received by the transmitting device (e.g., were not received or included errors). As used herein, the phrases “not received” and “not properly received” may be used interchangeably.

In FIG. 7, a first frame transmitted by a transmitting device representing a first fragment of a first MSDU (i.e., M1F1) has a Dly-ACK policy. A second transmitted frame representing a second fragment of a second MSDU (i.e., M1F2) also has a Dly-ACK policy. A third transmitted frame representing a third fragment of a first MSDU has a Dly-ACK policy with a request (Req) for acknowledgment. The first frame fails an HCS and/or FCS check, which is indicated with an “X.” The receiving device sends a first acknowledgement that the second and third frames were received (M1-F2,3) in response to the third transmitted frame with the request for acknowledgement. Since the first acknowledgement is not received by the transmitting device (which is indicated with an “X”), the transmitting device sends a fourth frame that is identical to the third frame. The receiving device sends a second acknowledgement indicating that the second and third frames were received in response to the fourth transmitted frame.

When an acknowledgement for a frame with an 1 mm-ACK or Dly-ACK policy is expected, but not received during a specified time, the transmitting device retransmits the frame (or a new frame if the failed frame's retransmission limit has been met, e.g., twice) after the end of a specified time. Because the transmitting device sending the data frame may not correctly receive an acknowledgment, duplicate frames may be sent even though the intended recipient has already received and acknowledged the frame. The retransmitted frames can be assembled in the same burst with other originally transmitted frames, shown in FIG. 7, to increase the signal-to-noise ratio.

In a conventional system, the third and fourth transmitted frames are scrambled with different seed values. Different seed values cause the scrambler to generates different bit streams for the same source data and, thus, the payload data may be different for frames with the same source data. This results in different HCS and FCS values. In accordance with one aspect of the present invention, these frames may be scrambled using the same seed values, e.g., under control of the MAC layer. In an exemplary embodiment, incremental and circular seed settings are used for the first transmission of frames and retransmitted frames are assigned with the same scrambler seeds as the originally transmitted frames. In addition to the same scrambler setting, the retransmitted frames may be encoded with the same encoder as the originally transmitted frames. The retransmitted frames may be mapped with the same mapper as the originally transmitted frames or a different mapper and the retransmitted frames may be modulated with the same modulator as the originally transmitted frames or a different modulator. In accordance with these embodiments, the same payload may be obtained, which makes it possible to combine the payload portion 306 during demodulation in the receiving device.

In a conventional system, the first time a frame is sent a ‘retry’ bit 518 in the MAC header field 310 is not set. On subsequent transmissions of the same frame, the ‘retry’ bit 518 is set. From FIG. 5, it is seen that different values of the ‘retry’ bit 518 in the MAC header field 310 for transmitted and retransmitted frames results in different HCS, or different header portion 304 values, which inhibits combination of the header portion 304 in demodulation. In an exemplary embodiment, the retry bit may be ignored during calculation of the HCS. In an alternative exemplary embodiment, the retry bit may be set to the same value for all transmissions or may be removed from the MAC header 310 to make the MAC header 310 the same for transmitted and retransmitted frames.

In a conventional system, reliable indicators identifying the start of a burst are not present and, therefore, a receiving device may not be able to detect the start of bursts in case of failure in reception of the last frame. In accordance with one aspect of the present invention, reliable indicators may be introduced to assist in the identification of the start of a burst.

In an exemplary embodiment of the present invention, transmitted and retransmitted frames that fail either HCS or FCS checks are saved, e.g., by the PHY layer. The saved frames may then be combined during demodulation to obtain header data for use in passing the HCS check. A fragmentation control byte 504 may be used to identify the same frames. The same frames may also be combined during demodulation of payload data for use in passing FCS checks.

In an exemplary embodiment, duplicate MSDU fragments do not exist in the same burst. As long as the following condition holds true, there will not be two MSDU frame fragments with the same MSDU number in one burst. Assume that a burst contains a maximum of n_{B} frames, the maximum number of retries is n_{R}, and a bit number for an MSDU fragment is n_{b}. Equation 1 guarantees avoidance of two different frames with the same MSDU fragment in the same burst:

n_{B}×n_{R}≦2ⁿ^{_{b}} (1)

Additionally, to avoid ambiguity resulting from removal of the ‘retry’ bit, the following rules may be added to a specification for the MAC layer. For a new burst, if there are frames that are not acknowledged as correctly received, these frames are placed into the burst first if retransmission of these frames does not exceed the threshold of retransmission. Thus, frames for retransmission are put in the order of first-come-first-serve, which can reduce jitter in receiving time at the MSDU level.

One task of header demodulation is to get MSDU number and fragment numbers for packet assembly at the MAC layer. If equation (1) holds true, MSDU number and fragment numbers can be used to uniquely identify a frame. For ease of description, the term frame number is used hereinafter to represent MSDU number and fragment number.

In order to combine frames, frames with the same frame number are initially identified. If the header portion 304 passes HCS checking, the frame number can be extracted from the MAC header field 310 in the header portion 304. A bit error in the header portion 304, e.g., due to unreliable wireless channels, makes the header portion 304 useless for determining frame number. The frame number of a corrupted frame in the header portion 304, however, can be extracted from the correctly received frames before and/or after it.

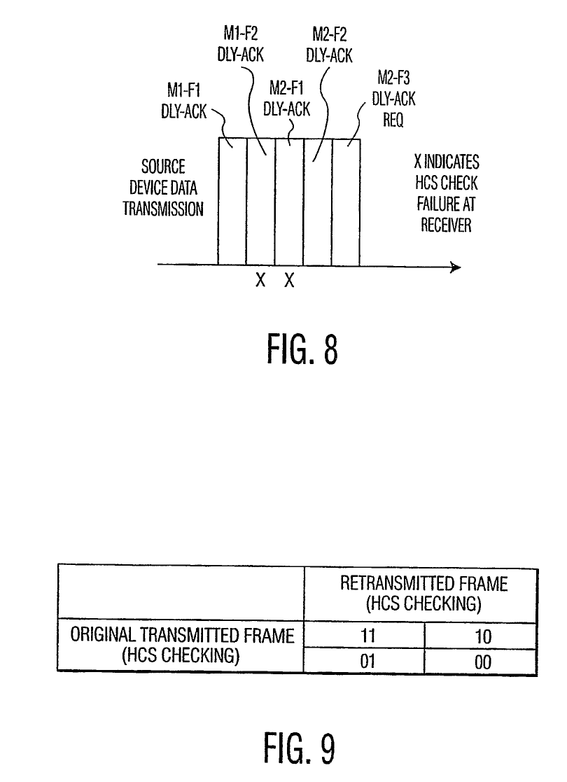

FIG. 8 illustrates extraction of a frame number for incorrectly received frames from correctly received frames. In this example, a ‘X’ indicates an HCS check failure at a receiving device. Thus, the first frame, fourth frame, and fifth frame pass an HCS check; and the second frame and the third frame do not pass the HCS check. The third frame (i.e., M2-F1) may be deduced from the fourth frame (M2-F2). Since there is no frame with ‘Fragment 0’, the second frame can also be deduced (i.e., M1-F2). From the first frame (M1-F1), the second frame is partially deduced (i.e., either M1-F2 or M2-F1). Since, in this example, the third frame is known (i.e., (M2-F2), the second frame can be fully deduced (i.e., M1-F2).

From the above operation we see that the frame number cannot be obtained at the moment when it is received for fail-to-pass-HCS-checking frames, but can be deduced at a later time when a pass-HCS-checking frame is received. The fail-to-pass-HCS-checking frame can be stored for processing after its retransmitted version is received in the next burst.

Another task of header demodulation is to obtain parameters from the PHY header necessary to demodulate payload data (i.e., seed identifier of scrambler, data rate of MAC frame body, and payload length). To obtain these parameters, the header portion of a frame has to pass HCS checking. FIG. 9 depicts four possibilities of HCS checking for transmitted and retransmitted frames. In FIG. 9, a ‘1’ indicates passing the HCS check while a ‘0’ indicates failing the HCS check.

If both frames pass the HCS check, the header portion from either frame may be selected for extraction of the parameters for demodulation of the payload data. If one of the frames passes the HCS check, the header portion of the frame that passes the HCS check may be selected for extraction of the parameters for demodulation of the payload data. If neither frame passes the HCS check, the header portions 304 of both frames are combined to increase the signal-to-noise ratio for that header portion. If the combined header portions 304 pass HCS checking, the combined header portions 304 are used for extraction of the parameters for demodulation.

In an exemplary embodiment, demodulation of a header is performed as follows for identified frames with identified frame numbers. First, the header portion 304 of a frame and a retransmission of that frame are demodulated. If one of the two frames passes an HCS check, the PHY layer extracts payload demodulation parameters from one of the frames that passed the HCS check. If both frames fail the HCS check, the PHY layer combines both frames to demodulate the header portion 304. If the combined frames pass HCS checking, the PHY layer extracts payload demodulation parameters from the combined frames. If the combined frames fail the HCS check, store the new combined frame is stored for a next combination. Although this example only describes two frames (i.e., one originally transmitted and one retransmitted), the principle can be applied to multiple frames.

In an exemplary embodiment, the PHY layer combines frames with the same frame number to get the frame payload. If the frame payload passes FCS checking, these frames are deleted from the storage. If it fails FCS checking, the new frame is stored for a next combination.

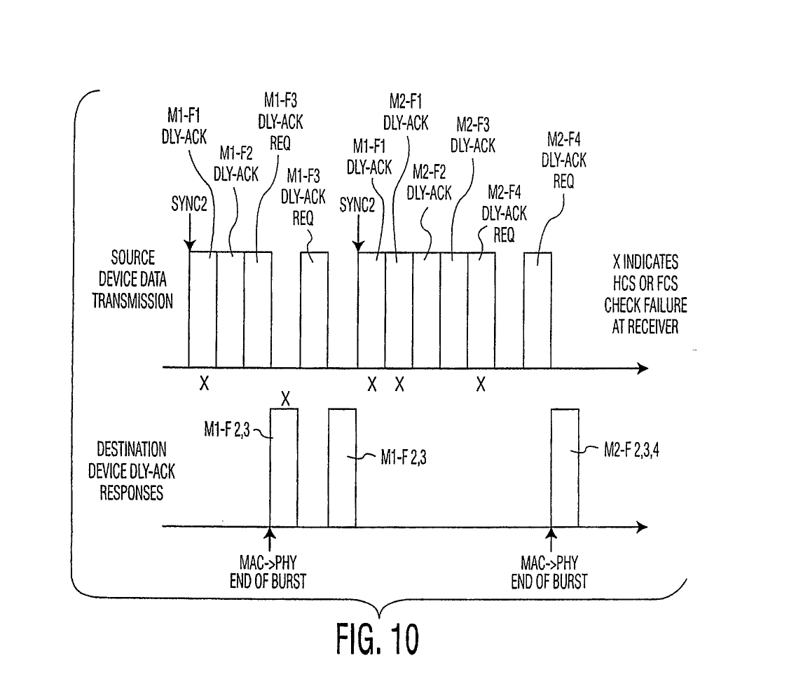

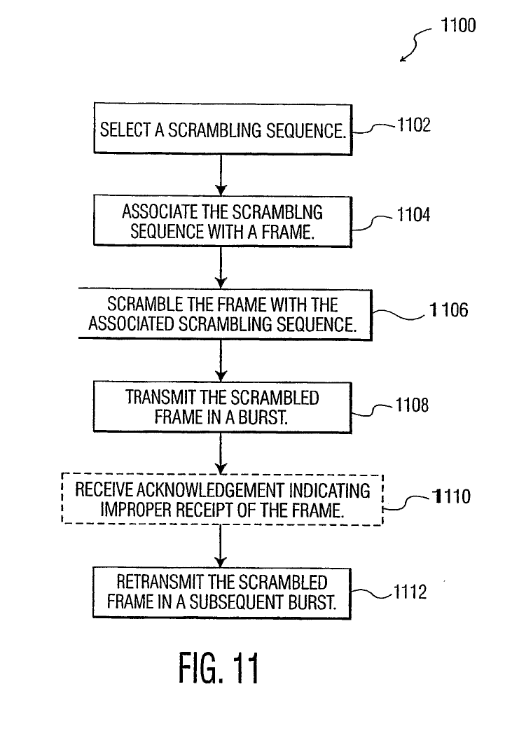

FIG. 10 illustrates a case in which a first frame in a burst is a retransmitted frame and is corrupted so that its frame number cannot be extracted upon its reception at the receiving device. In this example, the header portion 304 of the first frame (M1-F1) is corrupted so that the receiving device cannot extract a frame number. The transmitting device keeps on sending the first frame until it receives a response from the receiving device that indicates which frames are correctly received by receiver (i.e., M1-F2, 3 in the example). The transmitting device then starts another burst. In this subsequent burst, a retransmission of the first frame (M1-F1) is the first frame transmitted. In this example, the retransmitted frame is corrupted again. Without an indicator of a new burst, the receiving device is unable to determine whether it is another repetition of the first frame (i.e., M1-F1) or the start of a new burst. Thus, this frame cannot be used for combined demodulation. Since the receiving device knows that the first frame (M1-F1) will be the first frame in the next burst, if the receiving device also knows the start of the new burst, the receiving device can determine that the first frame in that burst will be the first frame (i.e., M1-F1). Thus, that frame can be combined with the first frame to improve the signal-to-noise ratio to obtain header information.

In accordance with an aspect of the present invention, the first frame in a burst will have a unique preamble. As described above, the preamble can tolerate some bit errors and, thus, is much more robust. In an exemplary embodiment, the preamble for a frame at the start of a burst is an inversion of the preamble for all other frames. Thus, the receiving device is able to detect a new burst from the detection of an inverted preamble. This scheme synchronizes the start of burst between transmitting and receiving devices using the preamble and is able to provide better performance than schemes that use only the PHY header 308 and the MAC header 310.

Memory management at the PHY layer may be resolved for storage of packets that fail FCS in the following manner. Whenever a receiving device receives a frame set with a Dly-ACK request, the MAC layer notifies the PHY layer. Based on the frame numbers, the PHY layer can determine how many copies of a particular frame are received. Copies of the same frame can then be combined to demodulate the header portion 304 and the payload portion 306.

FIG. 11 is a flowchart 1100 of exemplary steps performed by a transmitter in accordance with an aspect of the present invention. At block 1102, a scrambling sequence is selected. At block 1104, the selected scrambling sequence is associated with a frame for transmission. At block 1106, the frame is scrambled with the associated scrambling sequence. At block 1108, the scrambled frame is transmitted in a burst.

At block 1110, optionally, an acknowledgement indicator is received at the transmitter from a receiver indicating an improper receipt of the frame. In an exemplary embodiment, the receiver generates and transmits such an acknowledgement indicator to the transmitter if the frame was not received by the receiver or if the frame failed a checksum test such as an HCS or FCS test at the receiver. In an alternative exemplary embodiment, the receiver does not generate acknowledgement indicators and the step in block 1110 can be omitted.

At block 1112, the scrambled frame is retransmitted in a subsequent burst. In an exemplary embodiment, the transmitter generates and retransmits the scrambled frame in a subsequent burst in response to an indicator from a receiver device that indicates that the frame was not received or that the frame was not received in a usable form, e.g., it did not pass an HCS and/or an FCS check. The scrambled frame transmitted in block 1108 and retransmitted in block 1112 are scrambled using the same scrambling sequence and are identical to each other. In an alternative exemplary embodiment, where the receiver does not generate acknowledgement indicators, the scrambled frame may always be transmitted at least twice.

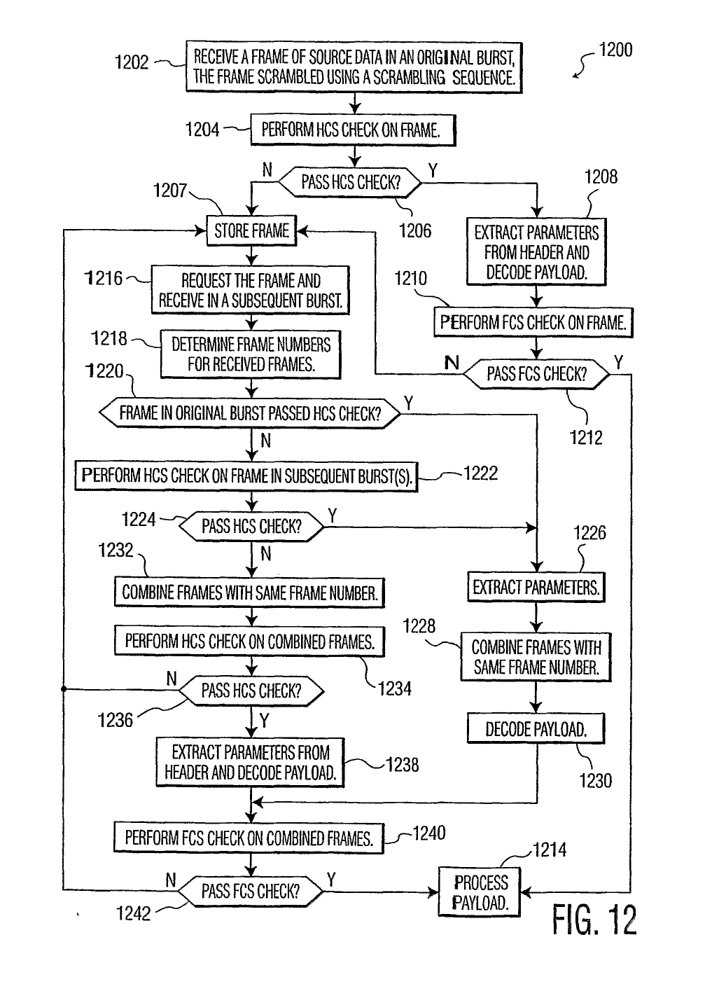

FIG. 12 depicts a flowchart 1200 of exemplary steps performed by a receiving device in accordance with an aspect of the present invention. At block 1202, a frame of source data is received in an original burst. The frame received in the original burst is a frame scrambled using a scrambling sequence.

At block 1204, a header check sum (HCS) check is performed on the received frame. At block 1206, a decision is made regarding the performed H CS check. If the frame passes the HCS check, processing proceeds at block 1208. If the frame fails the HCS check, however, processing proceeds at block 1207. At block 1207, the receiver stores the frame.

At block 1208, which is reached if the frame passes the HCS check, parameters for decoding the payload are extracted from the header and the payload is subsequently decoded.

At block 1210, a frame check sum (FCS) is performed on the frame. At block 1212, a decision is made regarding the FCS check. If the frame passes the FCS check, processing proceeds at block 1214 with processing of the payload within the frame. If the frame fails the FCS check, processing proceeds at block 1207.

At block 1216, which is reached if the frame fails either of the HCS check of block 1206 or the FCS check of block 1212, the receiver receives the frame in a subsequent burst. In an exemplary embodiment, the receiver requests that the frame be resent. In an alternative exemplary embodiment, every frame is resent in at least one subsequent burst.

At block 1218, frame numbers for received frames are determined. At block 1220, a decision is made regarding the HCS check performed at block 1206. If the frame in the original burst passed the HCS check, processing proceeds at block 1226. If the frame in the original burst failed the HCS check, however, processing proceeds at block 1222.

At block 1222, an HCS check is performed on the frame in a subsequent burst. If more than one subsequent burst of the frame has been received, the HCS check is performed on the frame in the most recent burst. At block 1224, a decision is made regarding the HCS check. If the frame passes the HCS check, processing proceeds at block 1226.

At block 1226, which is reached if an HCS check is passed for either the original burst or any subsequent burst, parameters are extracted from the frame that passed the HCS check.

At block 1228, frames having the same frame number are combined. At block 1230, payload data is decoded from the combined frames using the extracted parameters determined at block 1226.

At block 1232, which is reached if the HCS check at block 1224 fails, frames with the same number are combined. At block 1234, an HCS check is performed on the combined frames. At block 1236, a decision is made regarding the HCS check. If the combined frames pass the HCS check, processing proceeds at block 1238. If the combined frames fail the HCS check, however, processing proceeds at block 1207 with the storage of the combined frames and the receipt of the frame in another subsequent burst.

At block 1238, parameters are extracted from the header of the combined frames.

At block 1240, an FCS check is performed on the combined frames. At block 1242, a decision is made regarding the FCS check performed at block 1240. If the combined frames pass the FCS check, processing proceeds at block 1214 with processing of the payload of the combined frames. If the combined frames fail the FCS check, however, processing proceeds at block 1207 with the storage of the combined frames and the receipt of the frame in another subsequent burst.

Although the invention has been described in terms of a transmitter 100 and receiver 200, it is contemplated that the invention may be implemented in software on a computer (not shown). In this embodiment, one or more of the functions of the various components may be implemented in software that controls the computer. This software may be embodied in a computer readable carrier, for example, a magnetic or optical disk, a memory-card or an audio frequency, radio-frequency, or optical carrier wave.

Further, although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for enhancing communication in a wireless network, the wireless network transmitting bursts of frames, the method comprising the steps of:
transmitting a frame in a burst, at least a portion of the frame scrambled using a scrambling sequence;
storing an indicator corresponding to the scrambling sequence for the frame;
identifying the scrambling sequence of the frame for retransmission of the frame;
retransmitting the frame in a subsequent burst, at least a portion of the frame scrambled using the identified scrambling sequence.

2. The method of claim 1, wherein each frame within a burst includes a header portion and a payload portion and wherein the portion of the frame scrambled in the transmitting and retransmitting steps includes at least one of the header portion and the payload portion.

3. The method of claim 2, wherein each frame within the burst further includes a preamble and wherein the preamble of a first frame within the burst is different than the preamble of all subsequent frames within the burst.

4. The method of claim 3, wherein the preamble of the first frame within the burst is inverted with respect to the preamble of all subsequent frames within the burst.

5. The method of claim 2, wherein the header portion for the transmitted frame and the retransmitted frame are the same.

6. The method of claim 2, wherein the header portion includes a media access control (MAC) header and the MAC header includes a retry bit, and wherein the method further comprises the step of:
setting the retry bit in the frame for retransmission equal to the retry bit of the transmitted frame.

7. The method of claim 2, wherein the header portion includes a media access control (MAC) header and the MAC header includes a retry bit, and wherein the method further comprises the step of:
removing the retry bit from the frame for transmission and the frame for retransmission.

8. The method of claim 7, wherein at least one subsequent burst includes both one or more frames being transmitted for the first time and one or more frames being retransmitted and wherein the method further comprises the step of:
ordering the at least one subsequent burst such the frames being retransmitted are prior to the frames being transmitted for the first time.

9. The method of claim 1, further comprising the steps of:
selecting a seed value for scrambling the frame, the seed value associated with a scrambling sequence;
scrambling the frame with the scrambling sequence associated with the selected seed value for transmission; and
scrambling the frame with the identified scrambling sequence for retransmission;
wherein the identifying step includes identifying the seed value selected for scrambling the frame.

10. The method of claim 9, wherein the wireless network includes a media access control (MAC) layer and wherein the scrambling steps are performed under the control of the MAC layer.

11. A computer readable carrier including software that is configured to control a computer to implement a wireless communication method embodied in a computer readable medium for transmitting bursts of frames, the wireless communication method comprising the steps of claim 1.

12. A method for enhancing wireless communication in a wireless network, the wireless network transmitting bursts of frames, the method comprising the steps of:
receiving a frame in a burst, the frame scrambled using a sequence;
receiving the frame in a subsequent burst, the frame in the subsequent burst scrambled using the sequence; and
processing the frame received in the burst and the frame received in the subsequent burst to recover the frame.

13. The method of claim 12, wherein the processing step includes the step of:
combining the frame received in the burst with the frame received in the subsequent burst to increase a signal-to-noise ratio for the frame.

14. The method of claim 13, wherein the frame includes a header portion and a payload portion, the header portion includes a media access control (MAC) header, and the MAC header includes a retry bit, and wherein the combining step includes the step of:
ignoring the retry bit when combining the frame received in the burst and the frame received in the subsequent burst.

15. The method of claim 13, wherein the frame includes a header portion and a payload portion, the header portion includes a media access control (MAC) header, and the MAC header includes a retry bit, and wherein the processing step includes the step of:
removing the retry bit from the frames prior to combining the frame received in the burst and the frame received in the subsequent burst.

16. The method of claim 12, wherein each frame includes a header portion and a payload portion, the header portion includes a header checksum (HCS), and the payload portion includes a frame checksum (FCS), and wherein the method further comprises the steps of:
calculating a checksum for the header portion of the frame received in the burst;
comparing the calculated checksum for the header portion to the HCS; and
storing the frame received in the burst if the calculated checksum for the header portion does not match the HCS.

17. The method of claim 16, further comprising the steps of:
calculating a checksum for the payload portion of the frame received in the burst;
comparing the calculated checksum for the payload portion to the FCS; and
storing the frame received in the burst if the calculated checksum for the payload portion does not match the FCS.

18. The method of claim 16, wherein the wireless network includes a physical (PHY) layer and wherein the frame is saved by the PHY layer.

19. The method of claim 12, wherein each frame includes a header portion and a payload portion, the header portion includes a header checksum (HCS), and the payload portion includes a frame checksum (FCS), and wherein the processing step includes the steps of:
combining the frame received in the burst and the frame received in the subsequent burst;
calculating a checksum value for the header portion of the combined frames;
comparing the calculated checksum value for the header portion to the HCS; and
storing the combined frames received in the subsequent burst if the calculated checksum for the header portion does not match the HCS.

20. The method of claim 19, wherein the processing step further includes the steps of:
calculating a checksum value for the payload portion of the combined frames;
comparing the calculated checksum value for the payload portion to the FCS;
storing the combined frames received in the subsequent burst if the calculated checksum for the payload portion does not match the HCS; and
processing the combined frames to recover the frame.

21. The method of claim 19, wherein the wireless network includes a physical (PHY) layer and wherein the checksum value for the header portion of the combined frames is calculated by the PHY layer.

22. A computer readable carrier including software that is configured to control a computer to implement a wireless communication method embodied in a computer readable medium for transmitting bursts of frames, the wireless communication method comprising the steps of claim 12.
